(19) United States
(12) Patent Application Publication
(10) Pub. No.: US 2012/0257428 A1
(43) Pub. Date: Oct. 11, 2012

(54) Power Supply Circuit Device

(75) Inventor: Kosaku NOMURA, Daito-shi (JP)

(73) Assignee: Funai Electric Co., Ltd.

(21) Appl. No.: 13/437,117

(22) Filed: Apr. 2, 2012

(30) Foreign Application Priority Data
Apr. 11, 2011 (JP) 2011-087590

(51) Int. Cl. H02M 7/06

(52) U.S. Cl. 363/126

(57) ABSTRACT

A power supply circuit device comprises a relay, a main rectifier circuit, a standby rectifier circuit, a standby power supply circuit and a main power supply circuit. The main rectifier circuit rectifies an AC voltage from an external power supply, and inputs the rectified voltage to the main power supply circuit. The relay is inserted in the power supply path from the external power supply to the main power supply circuit, and is turned off in standby mode to turn off the voltage supply to the main power supply circuit, so that power consumption can be reduced. Since the voltage turned off by the relay is an AC voltage before being rectified by the main rectifier circuit, shock applied to the relay when turned off can be reduced, thereby reducing likelihood of failure and improving reliability.

### BACKGROUND OF THE INVENTION

1. Field of the Invention

The present invention relates to a power supply circuit device comprising a standby power supply circuit and a main power supply circuit in which the output of the main power supply circuit is turned off in standby mode.

2. Description of the Related Art

A conventional power supply circuit device to be provided in an electrical or electronic equipment comprises a standby power supply circuit for supplying voltage to a main control circuit in the electrical equipment and a main power supply circuit for supplying voltage to a peripheral circuit of the main control circuit (refer to e.g. Japanese Laid-open Patent Publication 2006-333608).

### BRIEF SUMMARY OF THE INVENTION

The power supply circuit device is driven by an AC (alternating current) voltage supplied from an external power supply, in which the AC voltage is rectified by a rectifier circuit, and the rectified voltage is smoothed by a smoothing circuit so as to be supplied to the standby power supply circuit and the main power supply circuit. When a standby command is sent from e.g. a remote control to the electrical equipment, the power supply circuit device is switched to standby mode to turn off the output of the main power supply circuit and stop the voltage supply to the peripheral circuit. This can reduce power consumption of the power supply circuit device.

In order to reduce power consumption of such a power supply circuit device in standby mode, it is known to insert a switch in a voltage supply path from the smoothing circuit to the main power supply circuit so as to make it possible to turn off the switch in standby mode (refer to e.g. Japanese Laid-open Patent Publication Hei 8-308236). However, in the known power supply circuit device, a DC (direct current) voltage is supplied through the voltage supply path, which is thus continuously supplied with the DC voltage to maintain a current flowing therethrough. Accordingly, when the switch is turned off to turn off the voltage supply, the voltage supply is forced to be turned off. This increases a shock (load) applied to the switch so that the repetition of turning on and off of the switch increases the likelihood of failure, reducing its reliability.

An object of the present invention is to provide a power supply circuit device which can reduce power consumption and can improve reliability.

According to the present invention, this object is achieved by a power supply circuit device comprising: rectifying means for rectifying an AC voltage supplied from an external power supply; a standby power supply circuit for outputting a voltage rectified by the rectifying means to a main control circuit in an electrical equipment; a main power supply circuit for outputting a voltage rectified by the rectifying means to a peripheral circuit of the main control circuit in the electrical equipment; and switching means inserted in a voltage supply path through which the AC voltage is supplied from the external power supply to the main power supply circuit, so as to switch the voltage supply path between conduction and non-conduction states to turn on/off the AC voltage supply to the main power supply circuit.

Each of the standby power supply circuit and the main power supply circuit comprises, as operation modes, normal mode in which the output of the standby power supply circuit and the output of the main power supply circuit are in on-state, and standby mode in which the output of the main power supply circuit is in off-state while the output of the standby power supply circuit is in on-state. The rectifier means comprises: a standby rectifier circuit for rectifying the AC voltage from the external power supply so as to output the rectified voltage to the standby power supply circuit; and a main rectifier circuit for rectifying the AC voltage from the external power supply separately from the standby rectifier circuit so as to output the rectified voltage to the main power supply circuit. Further, the switching means is arranged at a preceding stage of the main rectifier circuit so as to turn off the voltage supply to the main power supply circuit in the standby mode.

Preferably, the standby power supply circuit and the main power supply circuit have common ground. In the normal mode, input current to the standby power supply circuit in a forward direction from the external power supply and input current to the main power supply circuit in a forward direction from the external power supply flow through the standby rectifier circuit and the main rectifier circuit, respectively. Further, output current of the standby power supply circuit in a reverse direction to the external power supply flows through the common ground to the main rectifier circuit, and the output current of the standby power supply circuit along with output current of the main power supply circuit in a reverse direction to the external power supply flow through the main rectifier circuit.

According to the present invention, the switching means is turned off in standby mode to turn off the voltage supply to the main power supply circuit, so that power consumption can be reduced. Further, since the voltage turned off by the switching means is an AC voltage before being rectified by the main rectifier circuit, shock applied to the switching means when turned off can be reduced, thereby reducing likelihood of failure and improving reliability.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawing. It is to be noted that the drawing is shown for the purpose of illustrating the technical concepts of the present invention or embodiments thereof, wherein:

FIG. 1 is a schematic block diagram of an electrical equipment with a power supply circuit device according to an embodiment of the present invention.

### DETAILED DESCRIPTION OF THE INVENTION

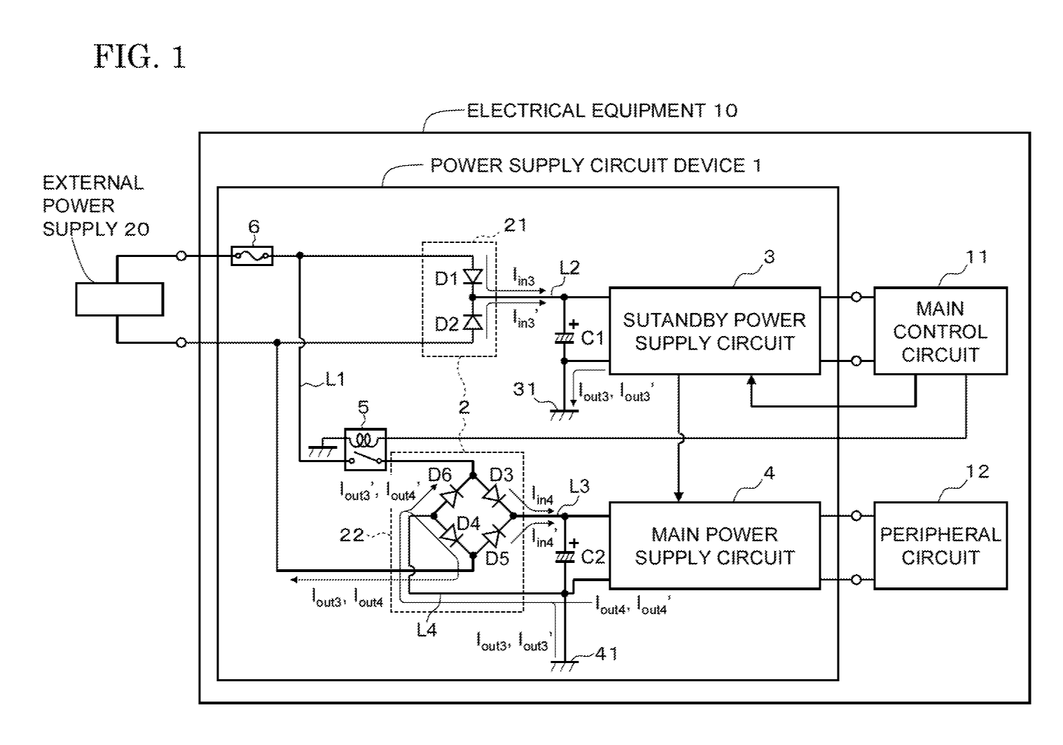

Embodiments of the present invention, as best mode for carrying out the invention, will be described hereinafter with reference to the drawing. The present invention relates to a power supply circuit device. It is to be understood that the embodiments described herein are not intended as limiting, or encompassing the entire scope of, the present invention. FIG. 1 is a schematic block diagram of an electrical equipment 10 with a power supply circuit device 1 according to an embodiment of the present invention. The power supply circuit device 1 is provided in the electrical equipment 10 which can be remotely controlled by a remote control, and which is, for example, a television receiver.

The power supply circuit device 1 comprises: a rectifier circuit 2 (rectifying means) for rectifying an AC (alternating current) voltage supplied from an external power supply 20; a standby power supply circuit 3 for outputting a voltage rectified by the rectifier circuit 2 to a main control circuit 11 in an electrical equipment 10; a main power supply circuit 4 for outputting a voltage rectified by the rectifier circuit 2 to a peripheral circuit 12 of the main control circuit 11 in the electrical equipment 10; and a relay 5 (switching means) inserted in a voltage supply path L1 through which a voltage is supplied from the external power supply 20 to the main power supply circuit 4. Each of the standby power supply circuit 3 and the main power supply circuit 4 comprises, as operation modes, normal mode in which the output of the standby power supply circuit 3 and the output of the main power supply circuit 4 are in on-state, and standby mode in which the output of the main power supply circuit 4 is in off-state while the output of the standby power supply circuit 3 is in on-state. Here, the standby power supply circuit 3 is connected to ground 31 that is common with ground 41 to which the main power supply circuit 4 is connected.

The main control circuit 11 includes: a receiver circuit for receiving operation signals wirelessly transmitted from a remote control; and a main IC (integrated circuit) for controlling various parts of the electrical equipment (power supply circuit device 1) based on the operation signals received by the receiver circuit. The peripheral circuit 12 includes a display controlled by the main IC. On the other hand, the rectifier circuit 2 comprises: a standby rectifier circuit 21 for rectifying an AC voltage from the external power supply 20 so as to output the rectified voltage to the standby power supply circuit 3; and a main rectifier circuit 22 for rectifying the AC voltage from the external power supply 20 separately from the standby rectifier circuit 21 so as to output the rectified voltage to the main power supply circuit 4. A fuse 6 is inserted in the voltage supply path from the external power supply 20 to the rectifier circuit 2.

The standby rectifier circuit 21 according to the present embodiment comprises a pair of series-connected diodes D1 and D2 which have cathodes connected in common and allow current to flow in the forward direction when the AC voltage is positive and negative, respectively. The cathode of each diode D1, D2 is connected by a wire as a positive lead L2 to an input terminal of the standby power supply circuit 3. When the AC voltage is positive, the diode D1 allows an input current Iᵢₙ₃ to flow in a forward direction from the external power supply 20 to the standby power supply circuit 3, which outputs an output current Iₒᵤₜ₃ to the ground 31 from an output terminal thereof. On the other hand, when the AC voltage is negative, the diode D2 allows an input current Iᵢₙ₃′ to flow in the same forward direction as the above from the external power supply 20 to the standby power supply circuit 3, which outputs an output current Iₒᵤₜ₃′ to the ground 31 from the output terminal. In this way, the standby rectifier circuit 21 supplies the input currents Iᵢₙ₃, 1ᵢₙ₃′ through the positive lead L2 to the standby power supply circuit 3, which outputs the output currents Iₒᵤₜ₃, Iₒᵤₜ₃′ to the ground 31. Here, the voltage rectified by the standby rectifier circuit 21 is smoothed by a smoothing element (capacitor) C1, and is then supplied to the standby power supply circuit 3.

The main rectifier circuit 22 is a bridge circuit for full-wave rectification and comprises four diodes D3, D4, D5, D6. The diodes D3, D4 are arranged to allow current to flow in the forward direction when the AC voltage is positive, while the diodes D5, D6 are arranged to allow current to flow in the forward direction when the AC voltage is negative. When the AC voltage is positive, the diode D3 allows an input current Iᵢₙ₄ to flow in a forward direction from the external power supply 20 to the main power supply circuit 4, and the diode D4 allows an output current Iₒᵤₜ₄ to flow in a reverse direction from the main power supply circuit 4 to the external power supply 20. On the other hand, when the AC voltage is negative, the diode D5 allows an input current Iᵢₙ₄′ to flow in the forward direction from the external power supply 20 to the main power supply circuit 4, and the diode D6 allows an output current Iₒᵤₜ₄′ to flow in the reverse direction from the main power supply circuit 4 to the external power supply 20.

The diodes D3 and D5 have cathodes connected in common. The cathode of each diode D3, D5 is connected by a positive lead L3 to an input terminal of the main power supply circuit 4 so as to allow the main rectifier circuit 22 to output the input currents Iᵢₙ₄, Iᵢₙ₄′ to the main power supply circuit 4 through the positive lead L3. On the other hand, the diodes D4 and D6 have anodes connected in common. The anode of each diode D4, D6 is connected to an output terminal of the main power supply circuit 4 by a negative lead L4 which is also connected to ground 41 so as to allow the main power supply circuit 4 to output the output currents Iₒᵤₜ₄, Lₒᵤₜ₄′ to the main rectifier circuit 22 through the negative lead L4.

At the same time, the output currents Iₒᵤₜ₃, Iₒᵤₜ₃′, which are output from the standby power supply circuit 3 described above, flow into the negative lead L4 through the grounds 31, 41. The output current Iₒᵤₜ₃ is a current to flow in a reverse direction from the standby power supply circuit 3 to the external power supply 20 when the AC voltage is positive, while the output current Iₒᵤₜ₃′ is a current to flow in the same reverse direction when the AC voltage is negative. The output currents Iₒᵤₜ₃, Iₒᵤₜ₄ flow in the reverse direction to the external power supply 20 through the diode D4, while the output currents Iₒᵤₜ₃′, Iₒᵤₜ₄′ flow in the reverse direction to the external power supply 20 through the diode D6. Here, the voltage rectified by the main rectifier circuit 22 is smoothed by a smoothing element (capacitor) C2, and is then supplied to the main power supply circuit 4.

The standby power supply circuit 3 is designed so that under the control of the main control circuit 11, the standby power supply circuit 3 sends the main power supply circuit 4 a command signal to command output on/off of the power supply for switching between normal mode and standby mode. The main power supply circuit 4 comprises an IC (integrated circuit) for turning on/off the output thereof in response to the control signal sent from the standby power supply circuit 3. Since the signals are thus provided from the standby power supply circuit 3 to the main power supply circuit 4, the ground 31 of the standby power supply circuit 3 is made common with the ground 41 of the main power supply circuit 4 (i.e. the standby power supply circuit 3 and the main power supply circuit 4 have common ground) to allow the signals to have the same potential in both circuits. The relay 5 is a switching element or switching means provided for switching the voltage supply path L1 between conduction and non-conduction states to turn on/off the voltage supplied to the main power supply circuit 4, and is turned off to turn off the voltage supplied to the main power supply circuit 4 (switch the voltage supply path L1 to the non-conduction state) in standby mode. The relay 5 is arranged at a preceding stage of the main rectifier circuit 22, and the on/off operation of the relay 5 is controlled by the main IC of the main control circuit 11.

Next, the operation of the power supply circuit device 1 in normal mode will be described. In normal mode, the input currents Iᵢₙ₃, Iᵢₙ₃′ to the standby power supply circuit 3 in the forward direction from the external power supply 20 and the input currents Iᵢₙ₄, Iᵢₙ₄′ to the main power supply circuit 4 in the forward direction from the external power supply 20 flow through the standby rectifier circuit 21 and the main rectifier circuit 22, respectively. Further, the output currents Iₒᵤₜ₃, Iₒᵤₜ₃′ of the standby power supply circuit 3 in the reverse direction to the external power supply 20 flow through the grounds 31, 41 (common ground) to the main rectifier circuit 22, and then the output currents Iₒᵤₜ₃, Iₒᵤₜ₃′ of the standby power supply circuit 3 along with the output currents Iₒᵤₜ₄, Iₒᵤₜ₄′ of the main power supply circuit 4 in the reverse direction to the external power supply 20 flow through the main rectifier circuit 22.

The operation of the standby rectifier circuit 21 will be described below. In normal mode, when the AC voltage supplied from the external power supply 20 is positive, the input current Iᵢₙ₃ is input to the standby power supply circuit 3 through the diode D1 and flows through the standby power supply circuit 3 so as to be output as the output current Iₒᵤₜ₃. The output current Iₒᵤₜ₃ flows through the grounds 31, 41 and the diode 4 in the reverse direction to the external power supply 20. On the other hand, when the AC voltage is negative, the input current Iᵢₙ₃′ is input to the standby power supply circuit 3 through the diode D2 and flows through the standby power supply circuit 3 so as to be output as the output current Iₒᵤₜ₃′. The output current Iₒᵤₜ₃′ flows through the grounds 31, 41, the diode 6 and the relay 5 in the reverse direction to the external power supply 20. In this way, in normal mode, the standby rectifier circuit 21 functions as a full-wave rectifier circuit.

In contrast, in standby mode, the relay 5 is turned off, so that the voltage supply path L1 is turned off when the AC voltage is negative. Thus, in standby mode, the standby rectifier circuit 21 functions as a half-wave rectifier circuit which allows a current to flow only when the AC voltage is positive. The power supply circuit device 1 of the present embodiment can reduce power consumption because in standby mode, the relay 5 is turned off to turn off the voltage supply to the main power supply circuit 4. In addition, the voltage of the voltage supply, which is turned off by the relay 5, is an AC voltage before being rectified by the main rectifier circuit 22, so that it is possible to reduce the shock applied to the relay 5 when the relay 5 (or the voltage supply) is turned off, making it possible to reduce the likelihood of failure and improve reliability.

One of the features of the power supply circuit device 1 of the present embodiment is that the main rectifier circuit 22 is a bridge circuit, while the standby rectifier circuit 21 is not. For comparison, let us assume that the rectifier circuit 2 were formed of two bridge circuits (more specifically that the standby rectifier circuit 21 were formed of a bridge circuit corresponding to the main rectifier circuit 22) arranged at preceding stages of the standby power supply circuit 3 and the main power supply circuit 4, respectively. Then, the power supply circuit device 1 would become unstable because when the output current from either the standby power supply circuit 3 or the main power supply circuit 4 flows in the reverse direction to the external power supply 20, the output current from either of them could flow to the external power supply circuit 20 through both the bridge circuit at the preceding stage of the standby power supply circuit 3 and the bridge circuit at the preceding stage of the main power supply circuit 4. This would make it difficult to sufficiently control current flowing through each of the standby power supply circuit 3 and the main power supply circuit 4, making it difficult to maintain the current at a predetermined value. This might cause an overcurrent to flow through and damage the diodes of the bridge circuits or the fuse 6 inserted between rectifier circuit 2 and the external power supply 20.

In contrast to this assumption, according to the present embodiment, the main rectifier circuit 22 is used as a fixed path for the output currents Iₒᵤₜ₃, Iₒᵤₜ₃′ to flow from the standby power supply circuit 3 in the reverse direction to the external power supply 20 and for the output currents Iₒᵤₜ₄, Iₒᵤₜ₄′ to flow from the main power supply circuit 4 in the reverse direction to the external power supply 20. This makes it possible to stabilize and control current flowing through each of the standby power supply circuit 3 and the main power supply circuit 4. Thus, it is possible to supply stable voltage to the main control circuit 11 and the peripheral circuit 12 from the standby power supply circuit 3 and the main power supply circuit 4. Furthermore, as described above, the standby rectifier circuit 21 functions as a full-wave rectifier circuit in normal mode while functioning as a half-wave rectifier circuit in standby mode. Thus, voltage to be supplied to the main control circuit 11 can be higher in normal mode than in standby mode. Accordingly, if the power required to drive the main control circuit 11 is high in normal mode and low in standby mode, the standby rectifier circuit 21 according to the present embodiment makes it possible to supply voltage as required, making it possible to prevent unnecessary power consumption.

It is to be noted that the present invention is not limited to the above embodiment, and can be modified in various ways according to the purpose of use within the spirit and scope of the present invention. The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

This application is based on Japanese patent application 2011-087590 filed Apr. 11, 2011, the content of which is hereby incorporated by reference.

1. A power supply circuit device comprising:
rectifying means for rectifying an AC voltage supplied from an external power supply;
a standby power supply circuit for outputting a voltage rectified by the rectifying means to a main control circuit in an electrical equipment;
a main power supply circuit for outputting a voltage rectified by the rectifying means to a peripheral circuit of the main control circuit in the electrical equipment; and
switching means inserted in a voltage supply path through which the AC voltage is supplied from the external power supply to the main power supply circuit, so as to switch the voltage supply path between conduction and non-conduction states to turn on/off the AC voltage supply to the main power supply circuit,
wherein each of the standby power supply circuit and the main power supply circuit comprises, as operation modes, normal mode in which the output of the standby power supply circuit and the output of the main power supply circuit are in on-state, and standby mode in which the output of the main power supply circuit is in off-state while the output of the standby power supply circuit is in on-state,
wherein the rectifier means comprises: a standby rectifier circuit for rectifying the AC voltage from the external power supply so as to output the rectified voltage to the standby power supply circuit; and a main rectifier circuit for rectifying the AC voltage from the external power supply separately from the standby rectifier circuit so as to output the rectified voltage to the main power supply circuit, and
wherein the switching means is arranged at a preceding stage of the main rectifier circuit so as to turn off the voltage supply to the main power supply circuit in the standby mode.

2. The power supply circuit device according to claim 1,
wherein the standby power supply circuit and the main power supply circuit have common ground,
wherein in the normal mode, input current to the standby power supply circuit in a forward direction from the external power supply and input current to the main power supply circuit in a forward direction from the external power supply flow through the standby rectifier circuit and the main rectifier circuit, respectively, and
wherein output current of the standby power supply circuit in a reverse direction to the external power supply flows through the common ground to the main rectifier circuit, and the output current of the standby power supply circuit along with output current of the main power supply circuit in a reverse direction to the external power supply flow through the main rectifier circuit.
